(19) United States
(12) Patent Application Publication
(10) Pub. No.: US 2015/0153006 A1
(43) Pub. Date: Jun. 4, 2015

(54) DAMAGE EVIDENT TRANSDUCER CABLE

(71) Applicant: FUJIFILM Sonosite, Inc., Bothell, WA (US)

(72) Inventor: Greg Nieminen, Bothell, WA (US)

(21) Appl. No.: 14/553,964

(22) Filed: Nov. 25, 2014

Related U.S. Application Data
(60) Provisional application No. 61/910,935, filed on Dec. 2, 2013.

(51) Int. Cl. F17D 5/02

(52) U.S. Cl. CPC F17D 5/02

(57) ABSTRACT

A medical cable that has been potentially damaged due to a severe bend, kink or other trauma, produces a visual indication of a location where the cable may have been damaged. In one embodiment, the cable is formed from a hollow tube where the walls of the tube contain dye-filled capsules or microspheres that break if subjected to trauma. The tube is formed of a transparent or semi-transparent polymer that allows the dye in the broken capsules to be seen thereby providing a visual indication of a location where the trauma has occurred.

### CROSS-REFERENCE TO RELATED APPLICATIONS

This application claims benefit of U.S. Provisional Patent Application Ser. No. 61/910,935, filed on Dec. 2, 2013, and entitled “DAMAGE EVIDENT TRANSDUCER CABLE,” which is hereby incorporated herein in its entirety by reference.

### TECHNICAL FIELD

The technology disclosed herein relates to medical instrument cables, and in particular, to medical instrument cables that are subject to trauma.

### BRIEF DESCRIPTION OF THE DRAWINGS

FIG. 1 shows a medical cable that extends between a connector and a transducer in accordance with one embodiment of the disclosed technology;

FIG. 2 shows a cut-away view of a medical cable that has not been kinked in accordance with an embodiment of the disclosed technology;

FIG. 3 shows a cut-away view of a medical cable that has been kinked in accordance with an embodiment of the disclosed technology; and

FIG. 4 shows a medical cable in accordance with another embodiment of the disclosed technology.

### DETAILED DESCRIPTION

In order to detect if a medical cable has been potentially damaged due to trauma, a cable in accordance with an embodiment of the disclosed technology, produces a visual indication of a location where the cable may have been damaged. In one embodiment, the cable is formed as a hollow tube where the walls of the tube contain dye-filled capsules or microspheres that break if subjected to trauma such as a kink or crush. In one embodiment, the tube is formed from a transparent or semi-transparent polymer that allows the broken dye capsules to be seen on the outside of the tube, thereby providing a visual indication of a location where the trauma has occurred.

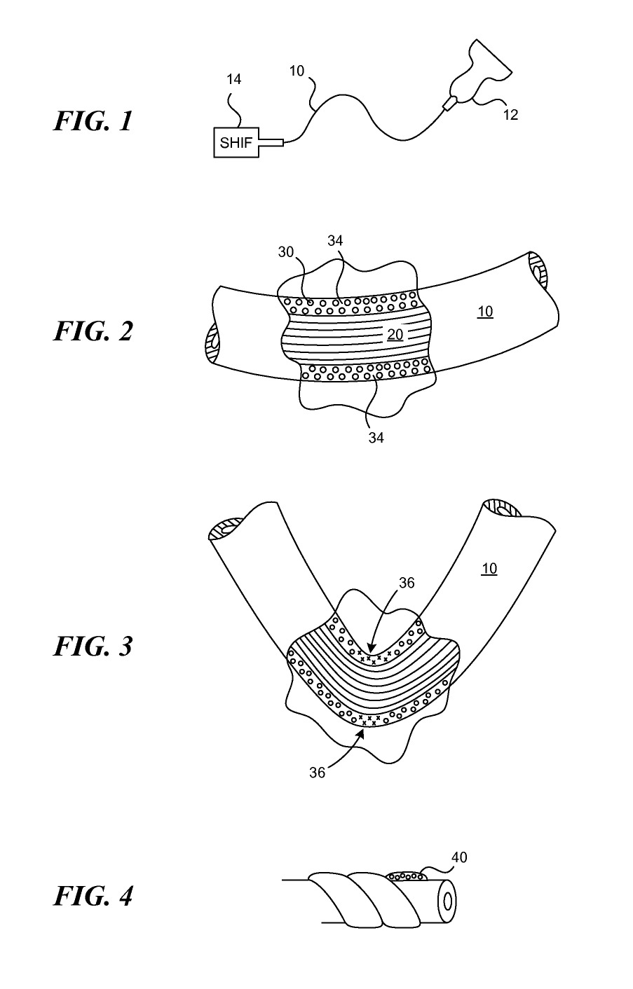

FIG. 1 shows a medical cable 10 in which a number of wires (not shown) are routed between a transducer 12 and a connector 14. In one embodiment, the transducer 12 may be an ultrasound imaging transducer and the connector 14 may be of the type that connects an ultrasound transducer to an ultrasound imaging machine or display. Alternatively, the medical cable 10 could be used with other medical equipment.

As will be appreciated by those of ordinary skill in the art, medical cables often carry a number of very thin wires/tubes or other components that can be damaged if bent too severely or subjected to other trauma (e.g., being crushed). However, the damage to such components after being bent may not be immediately apparent without performing a test procedure. Therefore, a user may not recognize that the cable has been damaged and continue to use it to examine patients even though the components in the cable may have been damaged. This could result in, for example, sub-optimal images and/or denial of patient treatment altogether.

To allow a user to be able to readily identify a cable that has been potentially damaged, the cable of the disclosed technology produces a visual indication of a location where the cable has been subjected to trauma.

As shown in FIG. 2, a cable 10 includes a hollow lumen 20 and a surrounding outer wall 30. Within the outer wall are a number of capsules 34 or microspheres that contain a dye or other chemical that becomes visible if the wall is bent beyond some predetermined amount or subjected to trauma. In one embodiment, the cable 10 is made from an extrusion of a transparent or semi-transparent material such as polyvinyl chloride (PVC) or vinyl that contains the dye-filled microspheres or capsules 34 and/or a pressure-sensitive substrate. Suitable capsules/microspheres include those described in, for example, U.S. Pat. Nos. 4,003,245 and 4,104,910, incorporated by reference herein in their entireties. Suitable capsules/microspheres may also include those used in, for example, Prescale film, available from Fujifilm. These materials and additives are available in a variety of pressure ratings from about 7 psi to 43,000 psi. In another embodiment, the capsules can contain a chemical (e.g., an acid) that reacts with the material of the outer wall, which could be a base, to produce a visual indication at the site of a trauma.

As will be appreciated by those skilled in the art, the selection of materials used for the cable 10 should allow the cable to be cleaned as necessary for use in a medical environment. In addition, the dye or other chemical in the capsules should be non-toxic.

FIG. 3 shows an example where the cable 10 is severely bent and some of the capsules (indicated by the x's) are broken thereby spilling dye into the wall of the cable. The dye creates a visual indication that the cable may have been damaged along with the location of the potential damage. The intensity and/or color of the dye can indicate, for example, the severity of the potential damage.

In one embodiment, the capsules/microspheres 34 are uniformly spread throughout the wall thickness of the outer wall 30. In another embodiment, the microspheres or capsules are located within a band having a thickness that is less than the thickness of the outer wall.

The visual appearance of the dye along a portion of the cable 10 alerts the user to the fact that the cable has been subjected to some sort of trauma such as by kinking it, stepping on it, running a cart over it etc. Therefore, the user can send the cable to a repair facility for inspection and repair or can dispose of it.

In one embodiment, the cable is manufactured with the dye-filled capsules or microspheres in it. In another embodiment, a sheath or wrap of a polymer that includes the dye-filled capsules or microspheres is placed over an existing cable as a retrofit.

In the embodiment shown in FIG. 4, the capsules 34 are contained in an overwrap of material 40 that is placed over a conventional cable. If the overwrap is subjected to trauma, the capsules/microspheres in the overwrap break to produce a visual indication of where the trauma may have occurred. The overwrap need not extend wholly over the cable. For example, a strip of material containing the capsules/microspheres could be placed along the length of the cable in order to provide a visual indication that the cable had been kinked.

In yet another embodiment the damage-indicating mechanism could be tuned to alert for specific types of damage that are more likely in different regions of the cable. For example, the end regions of the cable may be more prone to bending/kinking damage. More specifically, the region near the system connector, for example, may become wrapped tightly around the edges of the connector. The region near the system connector can thus, benefit from a bending/kinking indication. In some embodiments, a cable jacket configured to provide a tensile-indication can be included in and/or on a center section of the cable length. Again, this could be intrinsic with the cable jacket extrusion and/or be an overwrap. The reason for this is that bending/kinking deformation is local, but tensile loading is consistent along the cable length.

From the foregoing, it will be appreciated that specific embodiments of the invention have been described herein for purposes of illustration, but that various modifications may be made without deviating from the scope of the invention. Accordingly, the invention is not limited except as by the appended claims.

I/we claim:

1. A cable for a medical device, comprising:
a flexible tube having a hollow lumen in which components of the cable can be routed and a wall that surrounds the lumen; and
a number of capsules within the wall that are configured to break when subjected to trauma in order to produce a visual indication at a site of the trauma.

2. The cable of claim 1, wherein the capsules contain a dye.

3. The cable of claim 1, wherein the capsules contain a chemical that reacts with the tube to produce the visual indication at the site of the trauma.

4. A cable for a medical device, comprising:
a flexible tube having a hollow lumen in which components of the cable can be routed and a wall that surrounds the lumen; and
an overwrap of a material that includes a number of capsules within the overwrap that are configured to break when subjected to trauma in order to produce a visual indication at a site of the trauma.

5. A length of material that includes a number of capsules that are configured to break and produce a visual indication of where the material was subjected to trauma, wherein the material is configured to be placed on a cable such that if the cable is subjected to trauma, the capsules break and produce a visual indication of a site of the trauma.

6. The cable of claim 1, wherein the flexible tube is made of a transparent polymer.

7. The cable of claim 6, wherein the transparent polymer is polyvinyl chloride.

8. The cable of claim 6, wherein the transparent polymer is vinyl.
